(19) United States
(12) Patent Application Publication
(10) Pub. No.: US 2024/0280118 A1
(43) Pub. Date: Aug. 22, 2024

(54) Hydraulic Accumulator

(71) Applicant: Hydac Technology GmbH, Sulzbach / Saar (DE)

(72) Inventors: Peter Kloft, Ransbach-Baumbach (DE); Torsten Kusserow, Thörnich (DE)

(73) Assignee: Hydac Technology GmbH, Sulzbach / Saar (DE)

(21) Appl. No.: 18/571,424

(22) PCT Filed: Jun. 8, 2022
(86) PCT No.: PCT/EP2022/065518

§ 371 Date: Dec. 18, 2023

(30) Foreign Application Priority Data
Jun. 24, 2021 (DE) 10 2021 003 255.1

(51) Int. Cl. F15B 1/04

(52) U.S. Cl. CPC F15B 1/04; F15B 2201/4056

(57) ABSTRACT

The invention relates to a hydraulic accumulator having an accumulator housing (10) which is closed at least on a free end side by a cover part which is able to be fixed in the accumulator housing (10) via a threaded section, characterized in that, as part of the threaded section on the accumulator housing (10), an internal thread in the form of a round thread (26) is present, the individual thread flanks (28) of which enclose, in a notional extension, a flank angle (a) of 60° with one another, and in that the radius (R₁) of the rounded portion is larger in the head-side region (30) than the radius (R₁) in the root-side region (32) of the round thread (26).

### CROSS-REFERENCE TO RELATED APPLICATIONS

This application claims priority to German Patent Application No. DE 10 2021 003 255.1, filed on Jun. 24, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor (s), to the extent the work is described in this background section, as well as aspects of the description that may not otherwise qualify as prior art at the time of filing, are neither expressly nor impliedly admitted as prior art against the present disclosure.

The disclosure relates to a hydraulic accumulator having an accumulator housing which is closed at least on one free end face with a cover part which can be fixed in the accumulator housing along a threaded section.

DE 10 2018 005 204 A1 discloses a generic hydraulic accumulator, in particular in the form of a piston accumulator, having an accumulator housing and a separating element arranged therein, in particular in the form of a piston, which separates a fluid side from a gas side, it being possible to inspect at least the gas side by means of a sight glass in a cover part of the hydraulic accumulator, which cover part is configured to be fixable in the accumulator housing, in particular can be screwed in and out, along a threaded section.

In the known solution, the threaded section comprises an internal thread in the accumulator housing and a matching external thread in the cover part. Such hydropneumatic piston accumulators are closed in such a manner at the free open ends via the threaded section up to very large diameters using so-called compact covers as cover parts. In this way, very solid cover parts are thus screwed into the piston accumulator tube which forms the accumulator housing in the form of a cylindrical casing. In this case, the stiffness of the cylindrical casing of the accumulator housing is orders of magnitude lower than that of the compact cover part. In the event of failure due to fatigue, the fracture occurs in almost all cases at the first thread turn behind a thread undercut in the cylindrical casing of the accumulator housing. The fact that in this regard stress increases which can lead to fracture are actually present in this region can be demonstrated in the form of so-called FEM analyses.

The magnitude of the increased stress depends very heavily on the thread modulation and the associated notch effect. Furthermore, tests have shown that there can be large variations in the tests results. These “chaotic” variations occur even if the tubular accumulator housing and the compactly formed cover parts each consist of the same material batches. This is due to the smallest differences in the threads which are caused by different geometries of the manufacturing tools, even if they are within the permissible tool tolerances. Thus, wear or small chips occur on the tools which indirectly leads to the fatigue fractures in the thread turns of the machined threaded section.

The metric standard threads or ISO threads used up to now with an at least trapezoidal gradient for the respective internal thread which is introduced in the accumulator housing to create a correspondingly sensitive thread with respect to the notch effect and, in particular when high pressures or rapid pressure changes occur in the accumulator housing, this then results in fatigue fractures during operation and thus to failure of the hydraulic accumulator as a whole.

In the case of hydropneumatic pressure accumulator solutions or hydraulic accumulators, it has been proposed that the cylindrical ends of the accumulator housing be folded over the corresponding cover part by means of a flanging process and that a resulting fillet joint between the folded-over edge of the accumulator housing and the upper side of the cover part be permanently filled with a weld seam to fix the cover part to the accumulator housing. However, in the case of the solution to this effect, this connection can only be detached by destruction, so that such hydraulic accumulators have to be replaced with new accumulators in the event of failure, and basically it is not possible to open the accumulator housing, in particular for maintenance purposes or to replace the separating piston. In this respect, preference should be given to hydraulic accumulator solutions that have cover parts which can be screwed in and out of an accumulator housing.

### SUMMARY

Based upon this prior art, a need exists to improve a hydraulic accumulator to the effect that fatigue fractures are prevented even with a correspondingly high pressure load on the hydraulic accumulator.

The need is addressed by the subject matter of the independent claim(s). Embodiments of the invention are described in the dependent claims, the following description, and the drawings.

### BRIEF DESCRIPTION OF THE DRAWINGS

FIG. 1 shows a longitudinal section through the substantial components of an example hydraulic accumulator, in particular in the form of a piston accumulator but without illustration of the separating piston;

FIG. 2 shows a partial longitudinal section through an internal thread of the accumulator housing according to embodiments with parts of a standard thread;

FIG. 3 shows a partial longitudinal section through an external thread of the cover part according to embodiments with parts of a standard thread; and

FIG. 4 shows the internal and external threads cooperating along a threaded section according to FIGS. 2 and 3, respectively.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Since, in accordance with some embodiments, an internal thread in the form of a round thread is present as part of the threaded section on the accumulator housing, the individual thread flanks of which together enclose, in a notional extension, a flank angle of 60°, and since the radius of the rounding is greater in the crest-side region than the radius in the root-side region of the round thread, large, defined radii are implemented in the thread crest, as the crest-side thread region, and in the thread root, as the root-side thread region, so that the notch effect mentioned is significantly reduced for the internal thread of the accumulator housing and the undesirable fatigue fractures are prevented.

In some embodiments, it is provided that as a further part of the said threaded section on the cover part, an external thread in the form of a round thread is present, the individual thread flanks of which together enclose, in a notional extension, a flank angle of 60°, and that the radius of the rounding is smaller in the root-side region than the radius in the crest-side region of the external thread. In this way, within the threaded section, the thread flanks of the internal and external threads are in contact with each other, the thread turns adjacent to each other being radially spaced apart from each other. In this way, the fatigue and fracture strength is also increased for the external thread of the cover part and the aforementioned cooperation of the round thread of the internal thread of the accumulator housing with the external thread of the cover part results in hydraulic accumulator solutions, such as piston accumulator solutions, with a very long service life, even if the respective hydraulic accumulator design is subjected to high pressure loads and pressure cycling during operation.

Further embodiments of the hydraulic accumulator are the subject matter of the dependent claims.

The solution according to the invention is explained in greater detail below with reference to an embodiment according to the drawings. The drawings show in principle and are not to scale. Specific references to components, process steps, and other elements are not intended to be limiting. Further, it is understood that like parts bear the same or similar reference numerals when referring to alternate FIGS.

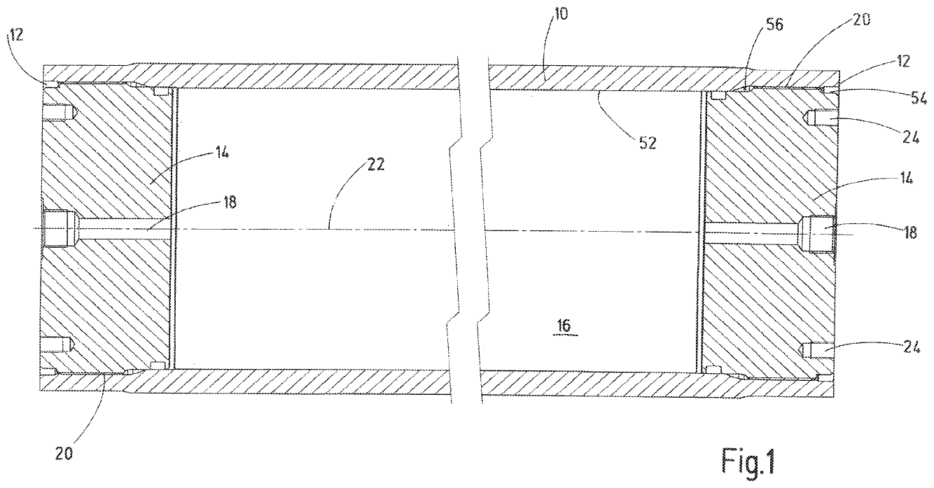

The hydraulic accumulator shown in the horizontal position in FIG. 1 has an accumulator housing 10 which forms a closed cylindrical hollow body casing. At each of its free opposing end faces 12, the accumulator housing 10 is closed by a cover part 14 which is configured as a solid compact cover. The two identically configured cover parts 14 seal an inner chamber 16 in the accumulator housing 10 with respect to the environment, a separating element which is not shown in greater detail being arranged in the inner chamber 16, for example in the form of a separating piston which is displaceably guided along the inner wall of the accumulator housing 10. Such hydraulic accumulator arrangements are disclosed, for example, in DE 10 2018 005 204 A1.

The separating element which is not shown in greater detail, in particular in the form of a separating piston, regularly separates a gas side from a liquid side inside the accumulator housing 10. The corresponding arrangement is also common, with the result that it will not be discussed in greater detail at this point. With regard to this embodiment, however, both cover parts 14 have an internal channel 18, by means of which the hydraulic accumulator can be connected, on the one hand, to a fluid circuit, such as a hydraulic circuit, which is not shown in greater detail and, on the other hand, can be filled via this internal channel 18 with a compressible working gas, such as nitrogen gas. After appropriate filling with working gas, the internal channel 18 is then sealed tightly to the outside, for example by means of a plug or the like.

The respective cover part 14 is fixed in the accumulator housing 10 via a threaded section 20. Along the one free end face of the cover part 14, screw-in holes 24 are introduced on its upper side diametrically to the longitudinal axis 22 of the accumulator housing 10, which screw-in holes serve to engage an actuating tool, not shown in greater detail, for screwing the respective cover part 14 into and out of the accumulator housing 10. The wall of the accumulator housing 10 is relatively thin compared to the very thick wall of the compact cover part 14 used in each case which, designed as a cylindrical solid component, is matched in terms of its external diameter to the internal diameter of the accumulator housing 10 along the threaded section 20.

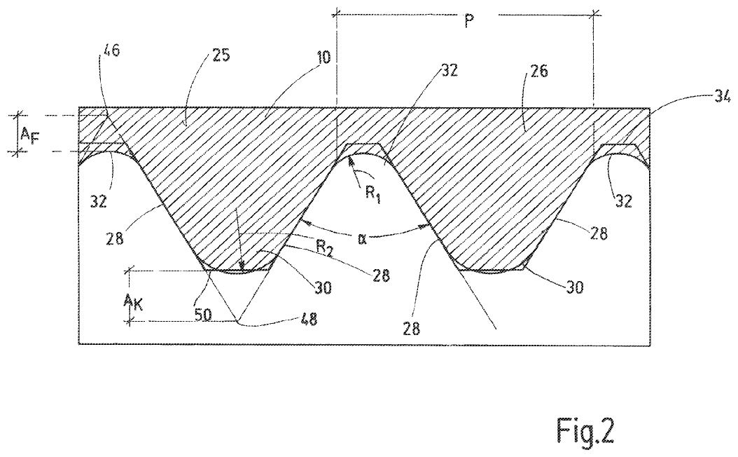

As shown in particular in FIG. 2, a round thread 26, designed as internal thread 25, is present as part of the threaded section 20 on the accumulator housing 10, the individual thread flanks 28 of which together enclose a flank angle α of 60° in a notional extension. As can further be seen from FIG. 2, the radius R₂ of the rounding in the crest-side region 30 is greater than the radius R₁ in the root-side region 32 of the round thread 26. For comparison, in addition to the round thread 26, a metric standard thread 34 in trapezoidal form is drawn in on FIG. 2, as is known for fixing cover parts 14 in associated accumulator housings 10. Like the round thread, the standard thread has a pitch P of 2 mm.

Other pitches P can be implemented if necessary. In the present case, a metric internal thread M210 x2 is implemented.

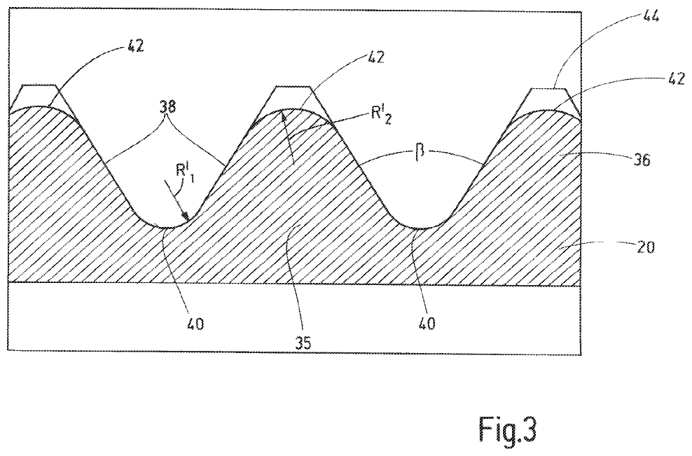

FIG. 3 now relates, as part of the threaded section 20 on the cover part 14, to an external thread 35, again in the form of a round thread 36, the individual thread flanks 38 of which together enclose a flank angle β of 60° in a notional extension. The radius R₁′ of the rounding in the root-side region 40 is smaller than the radius R₂′ in the crest-side region 42 of the external thread 35.

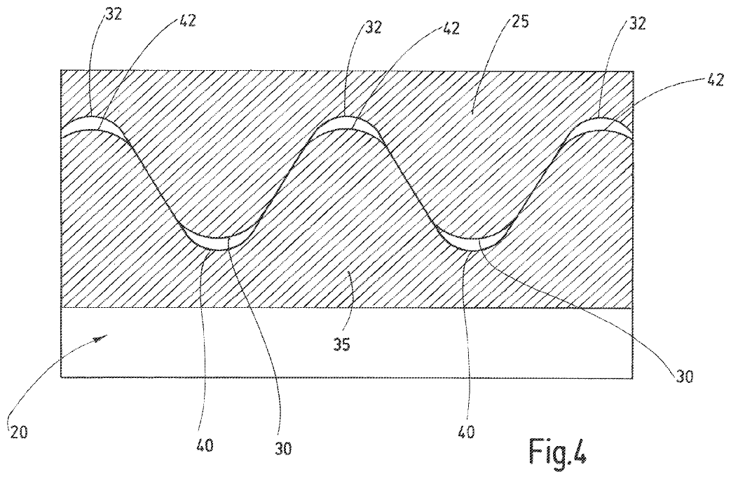

FIG. 3 again shows a previously used metric standard thread 44 which encloses the round thread 36 of the external thread 35 as an envelope and which, with corresponding pitch P, cooperates with the standard thread 34 according to FIG. 2 in the usual manner. Here again a value of 2 mm serves as the pitch for the round thread 36 as shown in the diagram according to FIG. 2. FIG. 4 now shows the cooperation of internal thread 25 of the accumulator housing 10 with external thread 35 of the cover part 14, the adjacent thread flanks 28, 38 being in contact with each other in pairs assigned to each other. Furthermore, the root-side and crest-side roundings are kept at a radial distance from each other, a rounding R₂, R₂′ with larger radius always meeting a rounding R₁′, R₁ with smaller radius, so that the respective rounding with the larger radius can support the smaller rounding via the thread flanks 28, 38 and accordingly notch effects in the thread root are reliably prevented even when the hydraulic accumulator is highly stressed.

According to the following formulae, the root-side rounding is R₁,

$${R}_{1}^{′} = \frac{1}{6}$$

H and the crest-side rounding R₂,

$${R}_{{2}^{=}}^{′} \frac{1}{5}$$

P where

$$H = \sqrt{\frac{3}{2} P}$$

and with P as the pitch of the round thread.

In the present case, the pitch is 2 mm which results in the value H as 1.73 mm. The roundings R₁, R₁′ then have a radius of 0.289 mm and the crest-side radii R₂, R₂′ are 0.4 mm. The nominal diameter in the region of the threaded section 20 for the hydraulic accumulator is given as 210 mm by way of example. Other values are conceivable here, all of which depend on the choice of pitch for the round thread 26 or 36.

As further emerges from FIG. 2, the notional extensions of two adjacent thread flanks 28 of the internal thread 25 of the accumulator housing 10 terminate in an acute angle, the angular apex 46 of which is at a distance

$${A}_{F} = \frac{1}{6} H$$

or a distance of 0.29 from the root-side rounding 32 at the lowest point which corresponds to the radius R₁, R₁′.

Furthermore, the notional extensions of two adjacent thread flanks 28 terminate in a further acute angle, the further root-side angular apex 48 of which extends to a secant 50, which runs along the free crest side of the standard thread with the same pitch P of 2 mm as the pitch determined for the round thread 26 of the internal thread 25 and passes through the crest-side rounding 30 of the internal thread 25, at a distance

$${A}_{K} = \frac{1}{4} H ,$$

which corresponds to a value of approximately 0.43 mm. As already explained, both threads of the threaded section 20 are designed with a nominal diameter which corresponds to approximately 100 times the pitch P of the respective round thread 26, 36 and, starting from a pitch P of 2 mm, here assumes the value of 210 mm.

As can be seen in particular from FIG. 1, the threaded section 20 extends along a free end region of the accumulator housing 10 in which the wall thickness of the accumulator housing 10 is reduced in such a manner that the threaded section 20 comes to lie within a notional extension of the other cylindrical inner wall region 52 of the accumulator housing 10. For effective load relief of the threaded section 20, it is further provided that said threaded section opens at its opposing ends in each case into an annular recess 54, 56 which is bounded by wall parts of the accumulator housing 10 and the cover part 14.

With the solution according to the teachings herein, a thread is implemented for fixing cover parts 14 in accumulator housings 10 of hydraulic accumulator solutions which is not sensitive to notches and their adverse effect on fatigue strength. The large, defined radii in the thread crest and the thread root with mutual flank support in the transition region are characteristic of the new thread with the result that the notch effects are effectively reduced. The trapezoidal standard threads otherwise used form thread pairings with extremely rigid “screws” compared to extremely thin-walled “nuts” which often leads to fatigue fractures due to the notch effect in the area of application mentioned. It is also atypical compared to such standard thread forms that in hydropneumatic accumulators the use of so-called fine pitch threads with smaller pitches leads to an increase in fatigue strength and thus ensures sustained operation of the hydropneumatic accumulator, even under high pressure loads. This has no equivalent in prior art.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module, or other unit or device may fulfill the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A hydraulic accumulator having an accumulator housing which is closed at least on a free end face by a cover part which can be fixed in the accumulator housing via a threaded section; wherein, as part of the threaded section on the accumulator housing, an internal thread in the form of a round thread is present, the individual thread flanks of which together enclose, in a notional extension, a flank angle (α) of 60°; and wherein the radius (R₂) of the rounding is larger in the crest-side region than the radius (R₁) in the root-side region of the round thread.

12. The hydraulic accumulator of claim 11, wherein as a further part of the threaded section on the cover part, an external thread in the form of a round thread is present, the individual thread flanks of which together enclose, in a notional extension, a flank angle (β) of 60°; and wherein the radius (R₁′) of the rounding is smaller in the root-side region than the radius (R₂′) in the crest-side region of the external thread.

13. The hydraulic accumulator of claim 11, wherein the root-side rounding (R₁, R₁′) of the internal and the external thread is R₁,
$${R}_{1}^{′} = \frac{1}{6}$$
H and the crest-side rounding (R₂, R₂′) of the internal and external thread is R₂,
$${R}_{2}^{′} = \frac{1}{5}$$
P, where
$$H = \sqrt{\frac{3}{2} P} ,$$
and where P is the pitch of the round thread.

14. The hydraulic accumulator of claim 11, wherein the notional extensions of two adjacent thread flanks of the internal thread of the accumulator housing terminate in an acute angle, the angular apex of which is at a distance
$${A}_{F} = \frac{1}{6} H$$
from the root-side rounding at the lowest point.

15. The hydraulic accumulator of claim 11, wherein the notional extensions of two adjacent thread flanks terminate in a further acute angle, the angular apex of which extends at a distance
$${A}_{K} = \frac{1}{4} H$$
from a secant, which runs along the free crest side of a standard thread with the same pitch as the pitch determined for the round thread of the internal thread and passes through the crest-side rounding of the internal thread.

16. The hydraulic accumulator of claim 11, wherein the nominal diameter of the threaded section is approximately one hundred times the pitch P of the respective round thread.

17. The hydraulic accumulator of claim 11, wherein the notional contour of a standard thread corresponding to the round thread of the cover part envelops the round thread.

18. The hydraulic accumulator of claim 11, wherein within the threaded section the thread flanks of the internal and external threads are in contact with each other and the thread turns R₂, R₁′; R₁, R₂′ adjacent to each other are spaced apart from each other.

19. The hydraulic accumulator of claim 11, wherein the threaded section extends along a free end region of the accumulator housing in which the wall thickness of the accumulator housing is reduced in such a manner that the threaded section comes to lie within a notional extension of the other cylindrical inner wall region of the accumulator housing.

20. The hydraulic accumulator of claim 11, wherein the threaded section, consisting of an internal and an external thread, opens at its opposing ends in each case into an annular recess which is formed by wall parts of the accumulator housing and the cover part.

21. The hydraulic accumulator of claim 12, wherein the root-side rounding (R₁, R₁′) of the internal and the external thread is R₁,
$${R}_{1}^{′} = \frac{1}{6}$$
H and the crest-side rounding (R₂, R₂′) of the internal and external thread is R₂,
$${R}_{2}^{′} = \frac{1}{5}$$
P, where
$$H = \sqrt{\frac{3}{2} P} ,$$
and where P is the pitch of the round thread.

22. The hydraulic accumulator of claim 12, wherein the notional extensions of two adjacent thread flanks of the internal thread of the accumulator housing terminate in an acute angle, the angular apex of which is at a distance
$${A}_{F} = \frac{1}{6} H$$
from the root-side rounding at the lowest point.

23. The hydraulic accumulator of claim 13, wherein the notional extensions of two adjacent thread flanks of the internal thread of the accumulator housing terminate in an acute angle, the angular apex of which is at a distance
$${A}_{F} = \frac{1}{6} H$$
from the root-side rounding at the lowest point.

24. The hydraulic accumulator of claim 12, wherein the notional extensions of two adjacent thread flanks terminate in a further acute angle, the angular apex of which extends at a distance
$${A}_{K} = \frac{1}{4} H$$
from a secant, which runs along the free crest side of a standard thread with the same pitch as the pitch determined for the round thread of the internal thread and passes through the crest-side rounding of the internal thread.

25. The hydraulic accumulator of claim 13, wherein the notional extensions of two adjacent thread flanks terminate in a further acute angle, the angular apex of which extends at a distance
$${A}_{K} = \frac{1}{4} H$$
from a secant, which runs along the free crest side of a standard thread with the same pitch as the pitch determined for the round thread of the internal thread and passes through the crest-side rounding of the internal thread.

26. The hydraulic accumulator of claim 14, wherein the notional extensions of two adjacent thread flanks terminate in a further acute angle, the angular apex of which extends at a distance
$${A}_{K} = \frac{1}{4} H$$
from a secant, which runs along the free crest side of a standard thread with the same pitch as the pitch determined for the round thread of the internal thread and passes through the crest-side rounding of the internal thread.

27. The hydraulic accumulator of claim 12, wherein the nominal diameter of the threaded section is approximately one hundred times the pitch P of the respective round thread.

28. The hydraulic accumulator of claim 13, wherein the nominal diameter of the threaded section is approximately one hundred times the pitch P of the respective round thread.

29. The hydraulic accumulator of claim 14, wherein the nominal diameter of the threaded section is approximately one hundred times the pitch P of the respective round thread.

30. The hydraulic accumulator of claim 15, wherein the nominal diameter of the threaded section is approximately one hundred times the pitch P of the respective round thread.
